(19) United States
(12) Patent Application Publication
(10) Pub. No.: US 2014/0029954 A1
(43) Pub. Date: Jan. 30, 2014

(54) Systems for Transmitting Control Signals Over a Fiber Optic Data Network and Related Methods and Apparatus

(71) Applicant: CommScope, Inc. of North Carolina, Hickory, NC (US)

(72) Inventor: Abhijit I. Sengupta, Alpharetta, GA (US)

(21) Appl. No.: 13/942,979

(22) Filed: Jul. 16, 2013

Related U.S. Application Data
(60) Provisional application No. 61/677,075, filed on Jul. 30, 2012.

(51) Int. Cl. G02F 1/125

(52) U.S. Cl. CPC G02F 1/125
USPC 398/141; 385/1

(57) ABSTRACT

Optical couplers for injecting an optical control signal onto an optical fiber include a micro-ring resonator that is coupled to the optical fiber, an optical transmission path and a modulator that is configured to vary a distance between the optical transmission path and the micro-ring resonator in order to selectively couple light from the optical transmission path onto the micro-ring resonator.

### CROSS-REFERENCE TO RELATED APPLICATION

The present application claims priority under 35 U.S.C. §119 from U.S. Provisional Patent Application Ser. No. 61/677,075, filed Jul. 30, 2012, the entire contents of which is hereby incorporated herein by reference as if set forth in its entirety.

### FIELD OF THE INVENTION

The present invention relates to fiber optic communications and, more particularly, to methods and systems that enable the transmission of control signals over a high data rate fiber optic data network.

### BACKGROUND

A fiber optic data network refers to a network of interconnected devices that transmit information (data) to each other (as well as to other devices over external networks or communications links) over fiber communications links such as fiber optic cables. Fiber optic data networks are presently being deployed in an increasing number of applications given the high data rates that can be transmitted over optical fibers and the decreasing cost of fiber optic cables and apparatus. By way of example, fiber optic data networks are now routinely used in data centers, skyscrapers, office buildings, sports arenas, aircraft, ships, shopping malls and the like to facilitate high speed data transfer between computing devices.

In many cases, it may be desirable to monitor or control the equipment and/or infrastructure associated with a fiber optic data network and/or to monitor or control devices that are interconnected via the fiber optic data network. It may likewise be desirable to monitor or control equipment that is located close enough to a fiber optic data network to be accessible via the fiber optic network. However, communicating monitoring and control data between centralized controllers and the nodes of a fiber optic network may require the deployment of additional network infrastructure which can increase the cost of deploying a fiber optic data network.

### SUMMARY

Pursuant to embodiments of the present invention, optical couplers are provided that may be used to inject an optical control signal onto an optical fiber. These optical couplers include a micro-ring resonator that is coupled to the optical fiber, an optical transmission path, and a modulator that is configured to vary a distance between the optical transmission path and the micro-ring resonator or to vary a distance between the optical fiber and the micro-ring resonator in order to selectively couple light from the optical transmission path onto the optical fiber via the micro-ring resonator.

In some embodiments, the modulator may be an ultrasonic acoustic modulator. The optical coupler may further include an optical source that is coupled to the optical transmission path. The optical source may be a light emitting diode or laser. The micro-ring resonator may be enclosed within a housing and the optical fiber may be received within a first side of the housing and a second optical fiber may also be received within the housing. The optical coupler may be part of a fiber optic data network that further includes a second optical coupler that has a second micro-ring resonator, a second ultrasonic acoustic modulator and a second optical transmission path. The ultrasonic acoustic modulator may be configured to inject a first modulated optical signal from the optical transmission path onto the optical fiber at a first modulation frequency and the second ultrasonic acoustic modulator may be configured to inject a second modulated optical signal from the second optical transmission path onto the optical fiber at a second modulation frequency that is different than the first modulation frequency. The optical source may emit a first optical signal at a first wavelength and the second optical coupler may include a second optical source that is coupled to the second optical transmission path that emits a second optical signal at a second wavelength that is different than the first wavelength.

Pursuant to further embodiments of the present invention, fiber optic data networks are provided that include a first network device that has an optical transmitter that is configured to transmit an optical signal having a first wavelength, a second network device and a fiber optic communications link that provides a data connection between the first network device and the second network device. These fiber optic data networks further include a first optical coupler that is configured to inject an optical control signal having a second wavelength that is different than the first wavelength onto the fiber optic communications link and a second optical coupler that is configured to extract the optical control signal from the fiber optic communications link.

In some embodiments, the first optical coupler may be a micro-ring resonator that is in optical communications with an optical fiber of the fiber optic communications link. The first optical coupler may include an optical transmission path that is coupled to an optical source and a modulator that is configured to vary a distance between the optical transmission path and the micro-ring resonator in order to selectively couple light from the optical transmission path onto the micro-ring resonator. The modulator may be an ultrasonic acoustic modulator. The optical source may be configured to generate the optical control signal as a modulated optical control signal that is coupled onto the micro-ring resonator. The optical control signal may comprise sensor data. The optical network may further include a third optical coupler that is configured to inject a second optical control signal onto the fiber optic communications link. This third optical coupler may be a micro-ring resonator that is in optical communications with the optical fiber of the fiber optic communications link

Pursuant to still further embodiments of the present invention, methods of communicating over an optical fiber are provided in which a first optical signal that has a first wavelength is transmitted from a first network device to a second network device over the optical fiber. An optical control signal that has a second wavelength that is different than the first wavelength is coupled from an optical transmission path onto the optical fiber via a micro-ring resonator.

In some embodiments, the method further comprises amplitude modulating the optical control signal by varying a distance between the optical transmission path and the micro-ring resonator using, for example, an ultrasonic acoustic modulator. The optical fiber may be a multi-mode optical fiber, the first wavelength may be 850 nm and the second wavelength may be 1310 nm. The optical control signal may include embedded data that identifies a connector port that receives an optical cable that includes the optical fiber. In some embodiments, the modulator may be a non-contact modulation device, while in other embodiments the modulator may be a contact modulation device that directly moves one of the optical transmission path or the micro-ring resonator.

Pursuant to additional embodiments of the present invention, optical couplers for injecting an optical control signal onto an optical fiber are provided that include a micro-ring resonator, a first optical transmission path, a second optical transmission path that is disposed between the micro-ring resonator and the optical fiber, and a modulator that is configured to vary at least one of a first gap between the first optical transmission path and the micro-ring resonator, a second gap between the micro-ring resonator and the second optical transmission path or a third gap between the second optical transmission path and the optical fiber in order to selectively couple light from the optical transmission path onto the optical fiber.

In some embodiments, the micro-ring resonator may be a first micro-ring resonator, and the second optical transmission path may include a second micro-ring resonator. The optical control signal may include patch cord connectivity data.

### BRIEF DESCRIPTION OF THE DRAWINGS

FIG. 1 is a schematic block diagram illustrating how an optical coupler according to certain embodiments of the present invention that includes a micro-ring resonator may be used to inject and extract optical control signals from an optical fiber of a fiber optic data network.

FIG. 2 is a schematic diagram of a micro-ring resonator that may be used in optical couplers according to embodiments of the present invention.

FIG. 3 is a schematic block diagram of a fiber optic data network according to certain embodiments of the present invention.

FIG. 4 is a schematic diagram of a highly simplified fiber optic data network that includes intelligent patching capabilities that is implemented using optical couplers according to embodiments of the present invention.

FIG. 5 is a enlarged, cut-away, schematic block diagram of one of the fiber optic patch panels included in the fiber optic data network of FIG. 4.

FIG. 6 is a flow chart illustrating methods of automatically tracking patching connections in a fiber optic data network according to certain embodiments of the present invention.

FIG. 7 is a flow chart illustrating methods of transmitting control signals over the primary communications links of a fiber optic data network according to certain embodiments of the present invention.

FIG. 8 is a schematic block diagram illustrating how a micro-ring resonator gap modulator may be located in different places according to embodiments of the present invention.

FIGS. 9A-9H are schematic diagrams of micro-ring resonator arrangements according to further embodiments of the present invention.

### DETAILED DESCRIPTION

Pursuant to embodiments of the present invention, fiber optic data networks are disclosed that may simultaneously carry high data rate network traffic between various devices that are interconnected by the network while, at the same time, using the same optical fibers that carry the high data rate network traffic to communicate control signals to and/or from a network manager computer or other control device or devices. As the control signals are carried by the same cabling that carries the network data traffic, the cost of providing the control capabilities may be significantly decreased. Moreover, the networks according to embodiments of the present invention may carry these control signals without significantly impacting or disrupting the high speed network data traffic, and may thus allow, for example, real time monitoring of equipment over the fiber optic data network. Herein the term “control signal” is used broadly to refer to any signal that is used for control purposes, without limitation, including, for example, command signals, interrogation signals, response signals, and signals containing control data such as status data, monitoring data, sensor data and the like.

According to some embodiments of the present invention, optical couplers that include micro-ring resonators may be used to inject optical control signals onto the optical fibers of an underlying fiber optic data network and/or to extract such optical control signals from the optical fibers of an underlying fiber optic data network. In particular, a micro-ring resonator may be provided at each node in the network where control data is to be injected or extracted. In some embodiments, various devices may be used to modulate an output of an optical source in order to inject modulated optical control signals onto optical fibers of the fiber optic data network. This modulation may be accomplished by “contact” modulation devices that, for example, directly contact one or both of an optical coupling that is attached to an optical source and the micro-ring resonator to vary the distance between the optical coupling and the micro-ring resonator or, alternatively, may be accomplished by “non-contact” modulation devices that apply pressure waves, magnetic forces or the like to “indirectly” vary the gap between the optical coupling and the micro-ring resonator. Examples of “contact” modulation devices that may be employed in embodiments of the present invention to modulate an output of an optical source in order to inject modulated optical control signals onto optical fibers of the fiber optic data network include vibrators, micro electrical-mechanical systems and the like, while examples of “non-contact” modulation devices that may be employed in embodiments of the present invention include ultrasonic generators and magnetic gap modulators.

Embodiments of the present invention will now be discussed with reference to the attached drawings, in which certain embodiments of the present invention are shown.

FIG. 1 is a schematic block diagram that illustrates how an optical coupler 10 according to certain embodiments of the present invention that includes a micro-ring resonator 20 that may be used to inject an optical control signal onto an optical fiber of a fiber optic data network and/or to extract an optical control signal from an optical fiber of a fiber optic data network.

As shown in FIG. 1, the optical coupler 10 may have a housing 12 that receives a first optical cable 30 of the fiber optic data network at one end thereof and a second optical cable 40 of the fiber optic data network at a second end thereof. Other than the first and second optical cables 30, 40 and the optical coupler 10, the fiber optic data network is not shown in FIG. 1 in order to simplify the drawing.

The optical coupler 10 may align plug terminations (not shown) that are included on the ends of optical cable 30 and optical cable 40 so that an end of a first optical fiber 32 of optical cable 30 is aligned with an end of a second optical fiber 42 of optical cable 40. Consequently, optical signals may be transmitted from the first optical fiber 32 onto the second optical fiber 42 and/or from the second optical fiber 42 onto the first optical fiber 32 through the optical coupler 10. The first and second optical fibers 32, 42 may constitute all or part of a first optical communications link 36 of the fiber optic data network that extends between a first network device 34 and a second network device 44. The first optical communications link 36 may be used to exchange network data between the first network device 34 and the second network device 44. This network data may be embedded in optical signals that are transmitted at a first wavelength. In the example implementation of FIG. 1, the first optical fiber 32 comprises a first multi-mode optical fiber 32 and the second optical fiber 42 comprises a second multi-mode optical fiber 42, and the network data is embedded in 850 nm optical signals that are transmitted between the first network device 34 and the second network device 44. While in the embodiment of FIG. 1 the optical coupler 10 is implemented as part of an optical connector that connects a first optical cable 30 to a second optical cable 40, it will be appreciated that in other embodiments the optical coupler 10 may be implemented in a middle portion of the optical cable 30 where the optical fiber 32 has been exposed in order to allow optical control signals to be coupled onto and/or from the optical fiber 32.

As is further shown in FIG. 1, the optical coupler 10 also includes a micro-ring resonator 20. The micro-ring resonator 20 may comprise, for example, a set of waveguides or other optical transmission paths that are arranged into at least one closed loop. The micro-ring resonator 20 may be mounted within the housing 12 to be in communication with at least one of the first optical fiber 32 and/or the second optical fiber 42. Further description of the structure, configuration and operation of an example micro-ring resonator 20 that is suitable for use with embodiments of the present invention will be provided below in the discussion of FIG. 2.

As is further shown in FIG. 1, the optical coupler 10 may be in communication with an optical source 50. The optical source 50 may be any suitable source for generating an optical signal including, for example, a semiconductor laser, a semiconductor light emitting diode (“LED”), an organic LED and the like. The optical source 50 may be connected to an optical transmission path 52 or “optical coupling” such as an optical fiber, a waveguide or the like or, alternatively, may be positioned to be directly in optical communication with the micro-ring resonator 20. The optical source 50 may generate a directly modulated optical control signal that is injected onto the optical transmission path 52. This optical control signal may then be coupled from the optical transmission path 52 to the micro-ring resonator 20. The micro-ring resonator 20 may then couple this directly modulated optical signal onto at least one of the first optical fiber 32 and/or the second optical fiber 42. In this fashion, the optical source 50 may inject a modulated optical control signal onto the first optical communications link 36.

In the depicted embodiment, the optical source 50 comprises a semiconductor laser that emits a 1310 nm optical control signal. This optical control signal is coupled onto the first optical communications link 36 via the micro-ring resonator 20. In some embodiments, the transmission loss through the micro-ring resonator 20 may be as low as less than 0.1 dB.

While, as discussed above, in some embodiments the optical source 50 may be configured to emit directly modulated optical signals, in other embodiments, the characteristics of the micro-ring resonator 20 may be used to couple a modulated optical control signal onto the optical communications link 36 from an unmodulated optical source 50. In particular, as shown in FIG. 1, in some embodiments, the optical coupler 10 may further include a micro-ring resonator gap modulator 60. The micro-ring resonator gap modulator 60 may be configured to mechanically alter a distance between, for example, the optical transmission path 52 and the micro-ring resonator 20. The micro-ring resonator 20 may comprise a highly selective device such that an optical signal at a specified wavelength that is transmitted over the optical transmission path 52 will couple to the micro-ring resonator 20 if a gap between the micro-ring resonator 20 and the optical transmission path 52 is less than a first distance, while the optical signal will not couple if the gap between the micro-ring resonator 20 and the optical transmission path 52 is greater than a second distance. The first and second distances may be very close together. For example, for a 1310 nm optical control signal, the first and second distances may be separated by a tens of microns or less. Consequently, very small changes in the distance between the optical transmission path 52 and the micro-ring resonator 20 may effectively determine whether or not an optical control signal that is transmitted on the optical transmission path 52 will couple onto the micro-ring resonator 20. Thus, by controlling the micro-ring resonator gap modulator 60 to alter the distance between the optical transmission path 52 and the micro-ring resonator 20, an amplitude modulated optical control signal may be injected onto the first optical communications link 36 via the micro-ring resonator 20.

In some embodiments, the micro-ring resonator gap modulator 60 may comprise an ultrasonic acoustic wave generator 62 that includes a piezoelectric material that generates an ultrasonic acoustic wave in response to an electrical control signal. The ultrasonic acoustic wave generator 62 may be positioned so that the wave output therefrom varies the gap between the optical transmission path 52 and the micro-ring resonator 20 by, example, physically moving one of the optical transmission path 52 and the micro-ring resonator 20. When the ultrasonic acoustic wave generator 62 increases the gap between the optical transmission path 52 and the micro-ring resonator 20, then the optical signal that is carried on the optical transmission path 52 will not couple onto the micro-ring resonator 20, while when the gap between the optical transmission path 52 and the micro-ring resonator 20 is narrowed, then the optical signal carried on the optical transmission path 52 will couple onto the micro-ring resonator 20. Thus, it is apparent that by controlling the electrical signal input to the ultrasonic acoustic wave generator 62, an amplitude modulated optical control signal may be injected into the micro-ring resonator 20. In some embodiments, very little power may be required to modulate the optical control signals that are injected into the micro-ring resonator 20, as very low power ultrasonic acoustic wave generators 62 may be used given the very small distances that the optical transmission path 52 must be moved to modulate the optical control signals onto the micro-ring resonator 20.

As will be discussed in more detail below, an optical control signal that is coupled onto the micro-ring resonator 20 may then be coupled from the micro-ring resonator 20 onto the first optical communications link 36. Thus, the optical couplers 10 may be used to couple an optical control signal onto the first optical communications link 36 of the fiber optic data network.

While in the embodiment of FIG. 1 the optical fibers 32 and 42 comprise multi-mode optical fibers, it will be appreciated that any suitable optical transmission medium may be used including, for example, single-mode optical fibers, multi-core optical fibers, waveguides, etc. It will likewise be appreciated that the network data signals and the optical control signals may be any appropriate wavelength optical signal, and are not limited to the 850 nm data signals and the 1310 nm optical control signals that are shown for purposes of example in FIG. 1. It will further be appreciated that the optical cables 30 and 40 may comprise single optical fiber cables or may include multiple optical fibers.

It will likewise be appreciated that any suitable micro-ring resonator gap modulator 60 may be used, and that embodiments of the present invention are not limited to the ultrasonic acoustic wave generator 62 that is depicted in the embodiment of FIG. 1. By way of example, in further example embodiments, vibrators or micro electro-mechanical (“MEMS”) devices may be used to implement the micro-ring resonator gap modulator 60.

Turning now to FIG. 2, a schematic diagram of a micro-ring resonator 100 is provided that may be used, for example, to implement the micro-ring resonator 20 of FIG. 1. As shown in FIG. 2, the micro-ring resonator 100 may comprise one or more waveguides 110 or other optical transmission paths that are formed in a closed loop. The waveguides 110 are positioned adjacent to an optical input 120 and an optical output 130. The optical input 120 may correspond, for example, to the optical transmission path 52 of FIG. 1. The optical output 130 may correspond to, for example, the first optical communications link 36 of FIG. 1.

Only a small range of wavelengths will resonate within the closed loop waveguides 110. Consequently, the micro-ring resonator 100 may function as a filter. Optical signals that are within the small range of resonant wavelengths may be coupled from the optical input 120 onto the closed loop waveguides 110. When this occurs, the optical signal at the resonant wavelength will circle the closed loop multiple times and build up in intensity due to constructive interference. When sufficient intensity has been built up, the optical signal may be output from the closed loop waveguides 110 to the optical output 130.

Referring again to FIG. 1, it should be noted that the first network device 34 and the second network device 44 communicate over the first optical communications link 36 using 850 nm optical signals. In contrast, the optical source 50 emits a 1310 nm optical signal. Consequently, the micro-ring resonator 20 that is included in the optical coupler 10 may be designed to receive 1310 nm optical control signals and to couple these 1310 nm optical control signals onto the first communications link 36. Since the micro-ring resonator 20 is designed to resonate with 1310 nm signals, the 850 nm optical signals that are transmitted between the first network device 34 and the second network device 44 over the first optical communications link 36 will not couple onto the micro-ring resonator 20.

The micro-ring resonators 100 may be implemented, for example, using CMOS semiconductor processing techniques, micro-imprinting methods or the like. As the normal data traffic (i.e., the 850 nm optical signals in FIG. 1) and the optical control signals (i.e., the 1310 nm optical signals in FIG. 1) are widely separated by wavelength, the micro-ring resonators 100 may have a relatively simple design and may be fabricated at low cost. In some embodiments, the micro-ring resonators 100 may be very small, and may be mass-produced using the above-mentioned processing techniques. The micro-ring resonators 100 may be precisely tuned to couple optical signals at specific wavelengths, while having virtually no effect on optical signals at other wavelengths such as, for example, optical signals at the wavelengths that are used to carry normal network data of the fiber optic data network.

FIG. 3 is a schematic block diagram of an fiber optic data network 200 according to certain embodiments of the present invention. As shown in FIG. 3, the fiber optic data network 200 may include a processor 210 that is located, for example, at a centralized location. The processor 210 may be electrically (or optically) coupled to a plurality of optical couplers 220 (which are labeled individually in FIG. 3 as optical couplers 220-1 through 220-N). Each of the optical couplers 220 may have the design of, for example, the optical coupler 100 of FIG. 2 that includes a micro-ring resonator. Each optical coupler 220 may include an optical source 222 and optical transmission path 224. The optical couplers 220 may be positioned next to a respective optical communications link 230 (which are individually labeled as communications links 230-1 through 230-N in FIG. 3) of a fiber optic data network. Network devices 240 (which are individually labeled as devices 240-1 through 240-N in FIG. 3) may be coupled to a first end of each communications link 230. The first end of the communications links 230 may or may not be at the centralized location.

As is further shown in FIG. 3, one or more nodes may be located on central or second end portions of each of the optical communications links 230. An optical coupler 250 may be provided at each of these nodes (which are labeled individually in FIG. 3 as optical couplers 250-1 through 250-M). The optical couplers 250 may have the design of, for example, the optical coupler 100 of FIG. 2. Each of the optical couplers 250 may be positioned next to one of the optical communications links 230, and each optical coupler 250 may include an associated optical source 252 and optical transmission path 254. A network device 260 may (but need not be) located at each node (these network devices are labeled individually in FIG. 3 as devices 260-1 through 260-M). Each of the optical couplers 250 may couple optical control signals that are generated by their respective optical sources 252 onto the optical communications link 230 to which they are adjacent. These optical control signals may be transmitted over the optical communications links 230 at the same time that normal network data is transmitted over the optical communications links 230. The optical control signals may be extracted from the optical communications links 230 by the optical couplers 220. The optical control signals may be passed by the optical couplers 220 to the processor 210. In this fashion, the nodes 250 may communicate control data to a centralized location using the optical fibers of an existing fiber optic data network.

As shown in FIG. 3, multiple optical couplers 250 may be located along the same optical communications link 230. If a particular optical communications link 230 includes multiple nodes, steps may need to be taken to allow the processor 210 to determine from which node an optical control signal was received. In some embodiments, this may be accomplished by having each optical source 252 in the network 200 insert identification data into each optical control signal that identifies the transmitting node. In other embodiments, each optical coupler 250 may be designed to have an optical source that is tuned to transmit an optical control signal at a unique wavelength, and the micro-ring resonators that are included in each optical coupler 250 may be designed to couple optical signals at these wavelengths. In such embodiments, the transmitting nodes may be identified based on the wavelength of the received optical control signals, as each optical coupler 250 along a particular optical communications link 230 may be designed to couple optical control signals that have different wavelengths. In still further embodiments, the optical couplers 250 may be configured to transmit the optical control signal onto their respective optical communications links 230 at different modulation frequencies, and these modulation frequencies may be used to identify the transmitting node. A variety of other techniques may also be used.

The techniques for coupling optical control signals onto an underlying fiber optic data network that are disclosed herein may be used in a wide variety of different applications. One example application where the techniques according to embodiments of the present invention may be useful is in tracking patching connections in high speed fiber optic data networks that are used to interconnect computer equipment such as servers, network switches, memory storage systems and the like. These networks are routinely installed in data centers, commercial office buildings, government facilities, educational campuses and the like. The optical couplers according to embodiments of the present invention may be used in such networks to transmit optical control signals that are used to automatically track the connections between the various devices that are interconnected via the fiber optic data network and/or to transmit other sensor data and environmental control signals over these fiber optic data networks. FIG. 4 is a schematic diagram of a highly simplified fiber optic data network for a data center or the like in which the techniques according to embodiments of the present invention are used to automatically track the patching connections between network devices.

As shown in FIG. 4, a plurality of network devices 311-315 (which are servers in the example of FIG. 4) may be mounted on a first equipment rack 310. These servers 311-315 may be connected to respective ones of a plurality of connector ports 330A-330H on a rack-mounted network switch 330. The network switch 330 routes packet-switched communications that are received from each server 311-315 toward their intended destination (which may be another network device within the data center or an external device that the server 311-315 is communicating with over an external network such as, for example, the Internet). The network switch 330 likewise routes packet-switched communications that are received from other network devices in the data center and from external sources to the servers 311-315. As is further shown in FIG. 4, a plurality of additional network devices 351-355 (which are memory storage devices in the example of FIG. 4) may be located on a rack 350 elsewhere in the data center. Each memory storage device 351-355 may likewise be connected to the network switch 330 (it will be appreciated that in a typical data center, hundreds or thousands of network switches are often provided; a single network switch is depicted in FIG. 4 in order to simplify the example).

Changes are routinely made to the network devices in a typical data center, with new devices being added, broken or obsolete devices being removed or replaced, equipment being relocated within the data center, etc. As these changes occur, it often becomes necessary to make temporary and/or permanent changes to the interconnection scheme. As one simple example, if a first memory storage device in a data center is scheduled to be replaced with a new memory storage device, servers and other computer equipment that use the first memory storage device may need to be temporarily connected to a second memory storage device until such time as the new memory storage device may be installed, configured, tested and brought online. In order to simplify the process of changing the connections between devices in a data center, the communications lines used to interconnect the servers, memory storage devices, routers and other computer equipment to each other and to external communication lines are typically run through sophisticated patching systems.

In the example of FIG. 4, the patching system comprises a first set of (two) patch panels 321, 322 that are mounted on an equipment rack 320, and a second set of (two) patch panels 341, 342 that are mounted on an equipment rack 340. In the simplified embodiment of FIG. 4, each of the patch panels 321, 322, 341, 342 includes eight connector ports A-H (e.g., the connector ports on patch panel 321 are connector ports 321A-321H) such as, for example, SC, LC and/or Multi-fiber Push On (“MPO”) fiber optic connector ports.

Focusing first on the upper portion of FIG. 4, it can be seen that a first set of patch cords 360 (only one patch cord 360 is shown in FIG. 4 to further simplify the drawing) is provided that connect each server 311-315 to the back side of a respective one of the connector ports 321A-321H on the first patch panel 321. A second set of patch cords 362 (only one patch cord 362 is shown in FIG. 4) is provided that connect the back side of each connector port 322A-322H on the second patch panel 322 to respective ones of the connector ports 330A-330H on the network switch 330. A third set of fiber optic cables 364 is provided that extend between the connector ports 321A-321H on patch panel 321 and connector ports 322A-322H on patch panel 322 (only one patch cord 364 is shown in FIG. 4). By choosing which connector ports 321A-321H and 322A-322H to plug each end of a particular patch cord 364 into, a technician can connect each of the servers 311-315 to any of the connector ports 330A-330H on network switch 330.

As shown in the lower portion of FIG. 4, a fourth set of patch cords 366 (only one patch cord 366 is shown in FIG. 4) is provided that connect the back side of each connector port 341A-341H on patch panel 341 to the network switch 330. A fifth set of patch cords 368 (only one patch cord 368 is shown in FIG. 4) is provided that connect the back side of each connector port 342A-342H on the patch panel 342 to respective ones of the memory storage devices 351-355. A sixth set of fiber optic patch cords 370 is provided that extend between the connector ports 341A-341H on patch panel 341 and connector ports 342A-342H on patch panel 342 (only one patch cord 370 is shown in FIG. 4). By choosing which connector ports 341A-341H and 342A-342H to plug each end of a particular patch cord 370 into, a technician can connect each of the memory storage devices 351-355 to any of a second plurality of connector ports (not visible in FIG. 4) on network switch 330.

As is further shown in FIG. 4, a rack manager 323 is provided, for example, on the same equipment rack as the patch panels 321, 322, and a rack manager 343 is provided, for example, on the same equipment rack as the patch panels 341, 342. The rack manager 323 may be in communication with processors that may be provided on patch panels 321, 322, and the rack manager 343 may be in communication with processors that may be provided on patch panels 341, 342. A system administrator computer (not shown) may also be provided that is in communication with the rack managers 323, 343. The rack managers 323, 343 and/or the system administrator computer may control operations of the intelligent patching system included in network 300 so that the connections of the patch cords 364 between connector ports 321A-321H and connector ports 322A-322H and the connections of the patch cords 370 between connector ports 341A-341H and connector ports 342A-342H are automatically tracked in real time and logged in a database each time a technician changes the connectivity of the end devices in the fiber optic data network 300 by rearranging the connector ports that the patch cords 364 and 370 are plugged into. As will be discussed below, optical couplers according to embodiments of the present invention may be used to inject and extract intelligent patching control signals onto and from the cabling of the fiber optic data network to automatically track the patching connections,

FIG. 5 is an enlarged, cut-away, schematic block diagram that illustrates various of the components that are included on one example embodiment of the fiber optic patch panel 321 of FIG. 5. The fiber optic patch panels 322, 341 and 342 may be identical to the patch panel 321, and hence will not be discussed further. The fiber optic patch panel 321 includes connector ports 321A-321H, only two of which are visible in the enlarged, cut-away view of FIG. 5. Each of the connector ports 321A-321H may (optionally) include an associated plug insertion/removal sensor 372. These plug insertion/removal sensors 372 are configured to detect each time a fiber optic patch cord is inserted into, or removed from, the front side of the respective connector ports 321A-321H. Each of the plug insertion/removal sensors 372 (if provided) may be electrically connected to a processor 374. In some embodiments, each plug insertion/removal sensor 372 may continuously transmit a control signal to the processor 374, with a voltage level of the control signal indicating either the presence (e.g., a high voltage level) or absence (e.g., a low voltage level) of a plug in the connector port 321A-321H with which each plug insertion/removal sensor 372 is associated. The plug insertion/removal sensors 372 may be implemented using, for example, mechanical sensors, optical sensors, electrical sensors, magnetic sensors, wireless technology (e.g., RFID tags, serial ID tags, etc.) or any other technology that may be used to detect when a plug is inserted into, or removed from, one of the connector ports 321A-321H.

The patch panel 321 further includes a plurality of optical couplers 380A-380H (only optical couplers 380A and 380B are visible in FIG. 5). The optical couplers 380A-380H may be, for example, the optical couplers according to embodiments of the present invention that are discussed herein such as the optical couplers 10 of FIG. 1. An optical transmitter/receiver 382 and an optical transmission path 384 may be provided adjacent to each optical coupler 380A-380H. Each optical coupler 380A-380H may be used to inject an optical control signal that is generated by its associated optical transmitter/receiver 382 onto an optical fiber of a patch cord 364 (see FIG. 4) that is plugged into the connector port 321A-321H that is associated with the optical coupler 380A-380H, and/or may be used to extract optical control signals from the optical fiber of the patch cord 364 and provide the extracted control signal to the associated optical transmitter/receiver 382.

As is further shown in FIG. 5, the processor 374 is in communication with the optical couplers 380A-380H and with the optical transmitter/receivers 382. The processor may control the optical couplers 380A-380H and the optical transmitter/receivers 382 to cause them to inject an optical control signal onto optical fibers of the patch cords 364 that are plugged into the connector ports 321A-321H and/or may receive optical control signals that are extracted from the optical fibers of the patch cords 364 via the optical couplers 380A-380H.

Examples of ways in which the fiber optic data network 300 may be operated to automatically track patching connections therein will now be described with reference to FIGS. 4-5 and the flow chart of FIG. 6. As shown in FIG. 6, operations may begin with a fiber optic patch cord 364 being coupled between a connector port (e.g., connector port 321B) on the first fiber optic patch panel 321 and a connector port (e.g., connector port 322G) on the second fiber optic patch panel 322 (block 400). A plug insertion/removal sensor 372 that is associated with the connector port 321B senses the insertion of the fiber optic patch cord 364 into connector port 321B, and sends a control signal to the processor 374 on patch panel 321 that indicates that this plug insertion has occurred (block 405).

In response to the plug insertion control signal, the processor 374 controls the optical coupler 380 and the optical transmitter/receiver 382 that are associated with connector port 321B to generate an optical control signal that is injected onto an optical fiber of the patch cord 364 that was plugged into connector port 321B (block 310). In this particular example, it will be assumed that the injected optical control signal includes a unique identifier embedded therein that identifies the connector port (i.e., connector port 321B of patch panel 321) at which the optical control signal was injected onto the optical fiber. The injected optical control signal will pass to the far end of the optical fiber which, in the present example, is plugged into connector port 322G of patch panel 322 (block 415).

As shown in FIG. 6, the optical coupler signal 380 that is associated with connector port 322G detects, and then extracts, the optical control signal from the optical fiber of the patch cord 364, and passes the extracted optical control signal to the optical transmitter/receiver 382 (block 420). The optical transmitter/receiver 382 extracts the data from the received optical control signal and passes this data to the processor 374 on patch panel 322 (block 425). The processor 374 reads the unique identifier of connector port 321B on patch panel 321 from the optical control signal and then notifies its rack manager 343 that a new patch cord connection has been identified that extends between connector port 321B on patch panel 321 and connector port 322G on patch panel 322 (block 430). In this fashion, the fiber optic data network 300 may use optical control signals to automatically track patching connections.

The fiber optic data network 300 may use the plug insertion/removal sensors 372 to detect the removal of patch cords, as these sensors 372 will notify the processors 374 on their respective patch panels 321, 322 each time an end of a fiber optic patch cord is removed from the connector ports thereon. Upon being notified of such plug removals, the rack manager 323 may delete the patch cord connection associated with the connector ports at issue from the database.

While the embodiments described with respect to FIGS. 5 and 6 include plug insertion/removal sensors 280, it will be appreciated that these sensors 280 may be omitted in other embodiments. In such embodiments, the intelligent patching system may, for example, periodically inject optical control signals serially at every connector port for injection onto any patch cord inserted therein in order to map the patch cord connections.

FIG. 7 is a flow chart illustrating methods of transmitting control signals over the primary communications links of a fiber optic data network according to certain embodiments of the present invention.

As shown in FIG. 7, operations may begin with the transmission of a first optical signal that has a first wavelength from a first network device to a second network device over an optical fiber of the fiber optic data network (block 450). Next, an optical control signal that has a second wavelength that is different than the first wavelength may be coupled into an optical coupler that includes a micro-ring resonator at one of the nodes of the fiber optic data network (block 455). This optical control signal may then be coupled from the micro-ring resonator onto the optical fiber (block 460). The optical control signal may be transmitted along the optical fiber to an intended destination (block 465). The optical control signal may be transmitted along the optical fiber at the same time that optical signals containing regular network data traffic are transmitted along the optical fiber. The optical control signal may be extracted from the optical fiber using an optical coupler that includes a second micro-ring resonator (block 470).

In some embodiments, the optical control signal may be amplitude modulated by varying the gap between an optical transmission path that receives light from an optical source that is used to generate the optical control signal and the micro-ring resonator of the optical coupler. In some embodiments, an ultrasonic acoustic modulator may be used to vary the distance between the optical transmission path and the micro-ring resonator. In some embodiments, the optical fiber may be a multi-mode optical fiber, the regular network data traffic may be transmitted using 850 nm signals and the optical control signals may be transmitted using 1310 nm signals.

It will be appreciated that many modifications may be made to the above-described embodiments without departing from the teachings of the present invention. By way of example, FIG. 8 is a schematic block diagram of an optical coupler 10′ that is very similar to the optical coupler 10 depicted in FIG. 1. However, as is illustrated in FIG. 8, pursuant to further embodiments of the present invention the micro-ring resonator gap modulator 60 (which may comprise, for example, an ultrasonic acoustic wave generator 62) which is included in the optical coupler 10′ may be used to vary the gap between the first and/or second optical cables 30, 40 and the micro-ring resonator 20 instead of varying the gap between the optical transmission path 52 and the micro-ring resonator 20 as is done in the optical coupler 10 depicted in FIG. 1. Thus, it will be appreciated that the gap-modulation may be performed at any suitable location.

Likewise, it will also be appreciated that the schematic micro-ring resonator configuration illustrated in FIG. 2 is just an example of one of numerous different configurations that may be used in embodiments of the present invention. FIGS. 9A-9H illustrate various additional micro-ring resonator configurations that may be used to couple control signals or the like from an optical input 120 (e.g., an optical transmission path that is coupled to an optical source) to an optical output 130 (e.g., an optical communications link of a fiber optic data network).

Turning to FIGS. 9A-9H, FIG. 9A illustrates a micro-ring resonator configuration 100-1 which is a mirror image of the micro-ring resonator configuration 100 illustrated in FIG. 2. The micro-ring resonator 100-1 may be used to send control signals in the opposite direction (as compared to the micro-ring resonator 100 of FIG. 2) on the optical output 130.

FIG. 9B illustrates a micro-ring resonator configuration 100-2 in which the optical input 120 is perpendicular to the optical output 130 as opposed to being parallel as in the embodiments of FIGS. 2 and 9A. It will be further be appreciated that any other angular relationship may exist between the optical input 120 and the optical output 130, and it will also be appreciated that the optical inputs and outputs 120, 130 need not be linear elements as is illustrated in the drawings. For example, the optical output 130 may comprise an optical fiber that may or may not be linear. FIG. 9C illustrates a micro-ring resonator configuration 100-3 which is a mirror image of the micro-ring resonator configuration 100-2 illustrated in FIG. 9B. The micro-ring resonator 100-3 may be used to send control signals in the opposite direction (as compared to the micro-ring resonator 100-2 of FIG. 9B) on the optical output 130.

Pursuant to still further embodiments of the present invention, multiple micro-ring resonators may be used to couple control signals or the like from an optical input 120 to an optical output 130. FIGS. 9D-9H illustrate five example embodiments where two micro-ring resonators are used. It will be appreciated that these embodiments are exemplary in nature, and that numerous other embodiments could also be used. It will also be appreciated that three or more micro-ring resonators could be used in still further embodiments.

As shown in FIG. 9D, in one example embodiment that is labeled 100-4, the optical input 120 may couple a control signal or the like onto a first micro-ring resonator 110, the control signal may then be coupled from the first micro-ring resonator 110 onto a second micro-ring resonator 115, and the control signal may then be coupled from the second micro-ring resonator 115 onto the optical output 130. The embodiment 100-5 of FIG. 9E is a mirror image of the micro-ring resonator configuration 100-4 illustrated in FIG. 9D, and may be used to send control signals in the opposite direction on the optical output 130.

As shown in the embodiment 100-6 of FIG. 9F, the first and second micro-ring resonators 110, 115 do not need to be linearly aligned with respect to the optical input 120 and the optical output 120. As is also apparent from FIGS. 9D-9F, the micro-ring resonators 110, 115 may be different sizes, if desired. Finally, FIGS. 9G and 9H illustrate two additional embodiments 100-7 and 100-8, respectively, in which two micro-ring resonators 110, 115 are used to couple a control signal from an optical input 120 to an optical output 130 that are perpendicularly disposed to each other. Once again, it will be appreciated that in further embodiments the optical input 120 and the optical output 130 could be at different angles with respect to each other.

As noted above, in some embodiments, a micro-ring resonator gap modulator 60 may be provided that is used to alter the distance between, for example, the optical input 120 and a micro-ring resonator (e.g., micro-ring resonator 110) in order to provide an amplitude modulated control signal that is injected onto the micro-ring resonator and ultimately onto the optical output 130. It will be appreciated that this micro-ring resonator gap modulator 60 may be positioned at any of the gaps between the various elements of the coupling system. By way of example, as shown in FIG. 9H by the reference numerals A, B and C, the micro-ring resonator gap modulator 60 may be used to modulate the gap between the optical input 120 and the first micro-ring resonator 110 (see reference numeral A), the gap between the first micro-ring resonator 110 and the second micro-ring resonator 120 (see reference numeral B) or the gap between the second micro-ring resonator 120 and the optical output 130 (see reference numeral C).

Herein reference is made to various optical data signals and optical control signals. It will be appreciated that these optical signals may be within or outside of the visible spectrum.

The present invention has been described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed above can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

Certain embodiments of the present invention have been described above with reference to the flowcharts of FIGS. 6 and 7. It will be understood that some blocks of the flowchart illustrations may be combined or split into multiple blocks, and that the blocks in the flow chart diagrams need not necessarily be performed in the order illustrated in the flow charts. It will also be understood that in some embodiments of the present invention the operations identified in some of the blocks in the flowcharts of FIGS. 6 and 7 may be omitted.

In the drawings and specification, there have been disclosed typical embodiments of the invention and, although specific terms are employed, they are used in a generic and descriptive sense only and not for purposes of limitation, the scope of the invention being set forth in the following claims.

1. An optical coupler for injecting an optical control signal onto an optical fiber, comprising:
a micro-ring resonator that is coupled to the optical fiber;
an optical transmission path; and
a modulator that is configured to vary a first distance between the optical transmission path and the micro-ring resonator or to vary a second distance between the optical fiber and the micro-ring resonator in order to selectively couple light from the optical transmission path onto the optical fiber via the micro-ring resonator.

2. The optical coupler of claim 1, wherein the modulator comprises an ultrasonic acoustic modulator.

3. The optical coupler of claim 1, further comprising an optical source that is coupled to the optical transmission path, wherein the optical source comprises a light emitting diode or laser.

4. The optical coupler of claim 1, wherein the micro-ring resonator is enclosed within a housing and the optical fiber comprises a first optical fiber, and wherein the first optical fiber is received within a first side of the housing and a second optical fiber is also received within the housing.

5. The optical coupler of claim 2, wherein the optical coupler comprises a first optical coupler that is part of a fiber optic data network, the micro-ring resonator comprises a first micro-ring resonator, the ultrasonic acoustic modulator comprises a first ultrasonic acoustic modulator and the optical transmission path comprises a first optical transmission path, the fiber optic data network further comprising a second optical coupler that includes a second micro-ring resonator, a second ultrasonic acoustic modulator and a second optical transmission path.

6. The optical coupler of claim 5, wherein the first ultrasonic acoustic modulator is configured to inject a first modulated optical signal from the first optical transmission path onto the optical fiber at a first modulation frequency and the second ultrasonic acoustic modulator is configured to inject a second modulated optical signal from the second optical transmission path onto the optical fiber at a second modulation frequency that is different than the first modulation frequency.

7. The optical coupler of claim 5, wherein the first optical coupler further includes a first optical source that is coupled to the first optical transmission path that emits a first optical signal at a first wavelength and the second optical coupler includes a second optical source that is coupled to the second optical transmission path that emits a second optical signal at a second wavelength that is different than the first wavelength.

8. A fiber optic data network, comprising:
a first network device that includes an optical transmitter that is configured to transmit an optical signal having a first wavelength;
a second network device;
a fiber optic communications link that provides a data connection between the first network device and the second network device;
a first optical coupler that is configured to inject an optical control signal having a second wavelength that is different than the first wavelength onto the fiber optic communications link;
a second optical coupler that is configured to extract the optical control signal from the fiber optic communications link.

9. The fiber optic data network of claim 8, wherein the first optical coupler comprises a micro-ring resonator that is in optical communications with an optical fiber of the fiber optic communications link.

10. The fiber optic data network of claim 9, wherein the first optical coupler further comprises an optical transmission path that is coupled to an optical source and a modulator that is configured to vary a distance between the optical transmission path and the micro-ring resonator in order to selectively couple light from the optical transmission path onto the micro-ring resonator.

11. The fiber optic data network of claim 10, wherein the modulator comprises an ultrasonic acoustic modulator.

12. The fiber optic data network of claim 9, wherein the first optical coupler further comprises an optical source that is connected to an optical transmission path, and wherein the optical source is configured to generate the optical control signal as a modulated optical control signal that is coupled onto the micro-ring resonator.

13. The fiber optic data network of claim 12, wherein the optical control signal comprises sensor data.

14. The fiber optic data network of claim 9, further comprising a third optical coupler that is configured to inject a second optical control signal onto the fiber optic communications link, wherein the third optical coupler comprises a micro-ring resonator that is in optical communications with optical fiber of the fiber optic communications link

15. A method of communicating over an optical fiber, the method comprising:
transmitting a first optical signal that has a first wavelength from a first network device to a second network device over the optical fiber;
coupling an optical control signal that has a second wavelength that is different than the first wavelength from an optical transmission path onto the optical fiber via a micro-ring resonator.

16. The method of claim 15, further comprising amplitude modulating the optical control signal by varying a distance between the optical transmission path and the micro-ring resonator.

17. The method of claim 16, further comprising using an ultrasonic acoustic modulator to vary the distance between the optical transmission path and the micro-ring resonator.

18. The method of claim 16, wherein the optical fiber comprises a multi-mode optical fiber, the first wavelength is 850 nm and the second wavelength is 1310 nm.

19. The method of claim 16, wherein the optical control signal includes embedded data that identifies a connector port that receives an optical cable that includes the optical fiber.

20. The optical coupler of claim 1, wherein the modulator is a non-contact modulation device.

21-24. (canceled)
